(19) United States
(12) Patent Application Publication
(10) Pub. No.: US 2007/0227889 A1
(43) Pub. Date: Oct. 4, 2007

(54) Exhaust gas sensor

(75) Inventors: Andreas Schaak, Ludwigsburg (DE); Goetz Reinhardt, Boeblingen (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 11/709,417

(22) Filed: Feb. 22, 2007

(30) Foreign Application Priority Data
Mar. 28, 2006 (DE) 10 2006 014 697.2

(51) Int. Cl. G01N 27/26

(52) U.S. Cl. 204/424

(57) ABSTRACT

An exhaust gas sensor, especially a lambda probe, preferably for motor vehicles, containing at least one reference electrode in a solid electrolyte and an exhaust gas electrode exposed to the exhaust gas, which has a porous ceramic coating is characterized by a circuit arrangement, through which an oxygen current flowing toward the exhaust gas electrode can be generated between a reference electrode and an exhaust gas electrode. The size of the oxygen current is adapted to the gas currents diffusing through the porous coating in such a way, that a targeted step change-displacement results.

The invention concerns an exhaust gas sensor, especially a lambda probe, preferably for motor vehicles, with the characteristics named in the preamble of claim 1, as well as a circuit arrangement to operate such an exhaust gas sensor with the characteristics indicated in the preamble of claim 4.

### STATE OF THE ART

An exhaust gas sensor, especially a lambda probe with a reference electrode disposed in a solid electrolyte and an exhaust gas electrode exposed to the exhaust gas is, for example, known from the German patent DE 41 31 503 A1.

The German patent DE 41 00 106 C1 discloses an exhaust gas probe, in which the electrode exposed to the exhaust gas is covered by a porous ceramic protective layer, in which catalytically active materials are distributed discretely and homogenously in such a way, that the discretely distributed catalytically active materials, preferably platinum, are active at elevated temperatures, whereas homogenously distributed active components, preferably rhodium, are active at low temperatures. By way of the small quantities of material of these substances, an improvement of the sensor closed-loop control is achieved especially at low temperatures. The sensor is moreover simple in machining to manufacture.

In such exhaust gas sensors with solid electrodes, which conduct oxygen ions, the transition from a rich to a lean mixture is measured by the measurement of the potential between the exhaust gas electrode and the reference electrode, which is exposed to a gas with a definite oxygen content, as, for example, the ambient air. This transition expresses itself through a significant step change of the sensor voltage during the transition from a rich to a lean mixture, which is also often designated as a lambda step change. The exhaust gas electrode is separated by a porous protective layer, which covers the exhaust gas electrode. The protective layer serves not only the mechanical protection of the exhaust gas electrode, but it also increases the so-called poisoning resistance.

Such exhaust gas sensors are deployed for the exhaust gas treatment of internal combustion engines. The step change characteristic at λ=1 of such a step change sensor or also such a two point lambda sensor is suitable for two point closed-loop controls. A control variable, composed of a voltage step change and a ramp, changes its positioning direction at each voltage step change, which indicates a change rich/lean or lean/rich. The amplitude of this control variable is established in this case typically in the range of 2 to 3 percent. Because of this a limited control unit dynamic occurs. The typical error measurement of the two point sensor, caused by the variation of the exhaust gas composition, can be compensated for by an open-loop control, in which the control variable progression is purposefully constructed symmetrically. The lambda accuracy in the dynamic operation amounts to typically 5 percent, so that fluctuations around λ=1 are unavoidable in this order of magnitude.

A cause for the small lambda accuracy lies with the different transport velocities of the so-called rich gases, that is to say of the hydrogen and the hydrocarbons and the so-called lean gases, i.e. of the oxygen and the nitrogen oxides in the protective layer. Because catalytically a balance arises at the exhaust gas electrode, a continuous delivery of rich and lean gases coupled with a continuous removal of the reaction products, carbon dioxide and water, takes place. In the process hydrogen diffuses, for example, faster in the protective layer than the lean gases. For this reason higher amounts of lean gases are required in order to completely convert the hydrogen than would correspond to the stoichiometric composition of the exhaust gas mixture. For this reason, the lambda step change is displaced into the lean range. Many hydrocarbons as, for example, propane diffuse in contrast slower than the lean gases. In this case the lambda step change displaces into the rich range. An additional cause for the displacement of the lambda step change is incomplete reactions at the exhaust gas electrode. In this case the exhaust gas electrode is not in the position to set the balance. In the case of the lean gases, such displacements occur, if no catalysis of the rich gases with nitrogen oxide occurs. Nitrogen oxide acts then like an inert gas and more oxygen is required to convert the rich gases. The lambda step change is thereby displaced into the lean range. In contrast hydrocarbons, which are not completely converted, require fewer lean gases. As a consequence of that, the entire characteristic curve and with that the lambda step change displaces into the rich range. The effects of the displacement of the lambda step change of the 2-point sensors occur, however only if the gas mixture is not in balance. This is the case if the 2-point sensor is operated upstream from the catalytic converter. Sensors, which are operated downstream from the main catalytic converter, receive a balancing gas mixture and show therefore a very precise lambda step change at lambda equals 1. The lambda accuracy is in this case better than 0.1%.

For an additional increase in the accuracy of the closed-loop lambda control, two sensor lambda closed-loop controls are used with exhaust gas sensors in the direction of flow of the exhaust gas in front of and behind the main catalytic converter in order to increase the accuracy of the entire closed-loop control system. The principle of the two sensor closed-loop control is based upon the fact, that the open-loop controlled rich displacement, respectively lean displacement, or the set point of a constant closed-loop control are changed comprehensively. In regard to exhaust gas sensors, which are deployed downstream from the catalytic converter, it is then desirable to displace the step change position into the slightly rich operation in order to improve the exhaust gas values. If the catalytic converter in fact delivers an overall slightly rich mixture, the exhaust gas contains practically no lean gases and especially no longer any nitrogen oxides, which can lead to a lambda step change. In this connection the oxygen storage capability of three way catalytic converters plays a decisive role. In the lean range surplus oxygen is in this instance stored in the catalytic converter, which in a succeeding rich phase is given off again. If the catalytic converter is loaded with oxygen, higher nitrogen oxide emissions result, which are undesirable.

Usually oxygen is stored in the three way catalytic converter during a transition from a rich to a lean mixture. An inherently known exhaust gas sensor installed downstream from the catalytic converter still indicates in this instance a rich mixture up until a complete saturation of the oxygen storage in the three way catalytic converter results. If the catalytic converter delivers in fact an overall slightly rich mixture, the exhaust gas contains practically no lean gases anymore, which can lead to a lambda step change.

### DISCLOSURE OF THE INVENTION

### ADVANTAGES OF THE INVENTION

The exhaust gas sensor according to the invention with the characteristics of claim 1 has on the other hand the advantage, that the step change position is also displaced slightly in the rich range, even when lean gases are absent. The basic idea of the invention is to “upset” the exhaust gas sensor to a certain degree, in order in this way to detect the beginning of a storage of oxygen in the catalytic converter. In so doing, the previously mentioned negative nitrogen oxide emissions, which arise during a saturation of the oxygen storage in the catalytic converter in the lean operation, can be prevented. The displacement into the rich range results in this instance by an additional oxygen source, which allows for the rich gases to be converted and which allow for a lambda step change displacement into the rich range. Only by means of this oxygen source is it possible for an exhaust gas sensor downstream from the catalytic converter to jump into the rich range.

A circuit arrangement according to the invention is formed by a series circuit constituted from a direct-current voltage source, a resistor and the exhaust gas sensor, whereby the plus terminal of the voltage source is connected directly or indirectly to the exhaust gas electrode, whereas the minus terminal is connected directly or indirectly to the reference electrode.

By means of this circuit arrangement, an oxygen current flowing toward the exhaust gas electrode can be generated between the reference electrode and the exhaust gas electrode. The oxygen current is adapted to the gas streams diffusing through the porous coating, so that a targeted lambda step change displacement occurs. In other words a targeted electrochemical pumping of oxygen occurs according to the invention to the exhaust gas electrode. By way of this pumping, the Nernst voltage of the sensor in fact decreases and thereby distorts the sensor signal. This distortion depends, however, very significantly on the amount of oxygen pumped per time unit, thus from the pumping current. The pumping current must therefore be maintained as small as possible. The effect of a fixed pumping current on the displacement of the step change position is determined on the other hand by the transport of the rich gases in the protective layer. Both currents, the pumping current of the oxygen through the solid electrolyte and the material current of the rich gases, meet at the exhaust gas electrode. In order that the desired effect of the pumping current emerges, the material current must therefore be selectively set through the porous protective layer.

By means of the steps which are listed in the dependent claims, advantageous modifications and improvements of the device presented in the independent claim are possible. Provision is made for a form of embodiment, in that the porous protective layer has several layers. In so doing, the layers can have advantageously in each case different porosities, whereby the “setting” is especially very well possible.

### SHORT DESCRIPTION OF THE DRAWINGS

Additional advantages and characteristics of the invention are the subject matter of the following description as well as the technical depiction of the examples of embodiment.

The figures show the following:

FIG. 1 schematically the construction of an exhaust gas sensor;

FIG. 2 a circuit arrangement made use of by the invention to operate the exhaust gas sensor depicted in FIG. 1;

FIG. 3 the sensor voltage by way of the air number λ at a first sensor;

FIG. 4 the sensor voltage by way of the air number λ at a second sensor and

FIG. 5 the displacement of the lambda step change as a function of the porosity of the porous coating of the sensors according to the invention.

### DESCRIPTION OF THE EXAMPLES OF EMBODIMENT

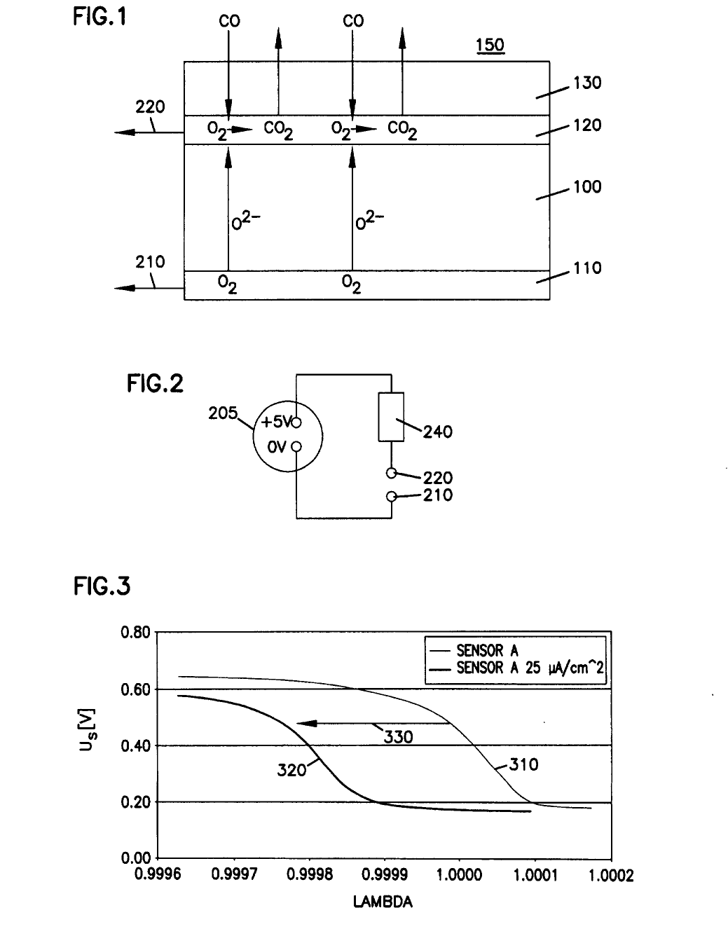

An exhaust gas sensor, depicted in FIG. 1, has a solid electrolyte 100, in which in an inherently known manner a reference electrode 110 and an exhaust gas electrode 120 are disposed. The exhaust gas electrode 120 is exposed to an exhaust gas. It is covered by a single or multiple ply porous protective layer 130. The exhaust gas sensor with the exhaust gas electrode 120 and the reference electrode 110 form an independent voltage source. A possible circuit is depicted in FIG. 2. The exhaust gas sensor is connected by way of a resistor 240 to an external voltage source 205, which delivers a constant direct-current voltage. At the terminal 220 of the reference electrode, the voltage 0V is present; whereas at the terminal 220 of the exhaust gas electrode 120, a voltage is present, which compared to the reference electrode has a negative voltage potential. The circuit with the external voltage source leads to the fact, that an oxygen current flows between the reference electrode 110 and the exhaust gas electrode 120. The magnitude of the oxygen current is determined by the voltage of the voltage source and the resistance 240. The system is so adjusted, that the flowing oxygen current only minimally decreases, i.e. only about a few millivolts, the voltage of the exhaust gas sensor present between the terminals 210 and 220. By means of this additional supply of oxygen, the exhaust gas sensor jumps in the rich range of the exhaust gas-air-mixture.

In order on the one hand to displace purposefully the step change position of the sensor into the rich range (also in the absence of lean gas) and on the other hand to decrease the voltage of the exhaust gas sensor only minimally by the flowing oxygen current, it is required to adjust the protective layer 130, which can comprise a single or multiple ply porous protective layers. A procedure to adjust a targeted porosity consists of adding suitable proportions of pore building to the base material of the protective layer 130. This can, for example, occur with a procedure described in the German patent DE 43 43 315 A1. The content of the German patent DE 43 43 315 is included in the patent application at hand in so far as the purpose of the disclosure is concerned. The adjustment of the porosity of the porous coating of the exhaust gas electrode 120 is thereby empirically assumed. In so doing, the proportions of porous buildings are added in such a way, for example by continually increasing or decreasing the corresponding proportions, that a supply of oxygen to the exhaust gas electrode 120 emerges, which leads to an increase of the oxygen content at the exhaust gas electrode 120 from 20 ppm to 200 ppm of oxygen.

In order to maintain the influence on the Nernst voltage to a minimum, the current density for that purpose should lie in the range from 25 μA/cm² with regard to the macroscopic surface of the exhaust gas electrode 120. The porosity of the porous coating is so adjusted, that the displacement of the lambda step change lies in the area of 1.2 to 9 ppm/(μA/cm²) in lambda (refer to FIG. 5).

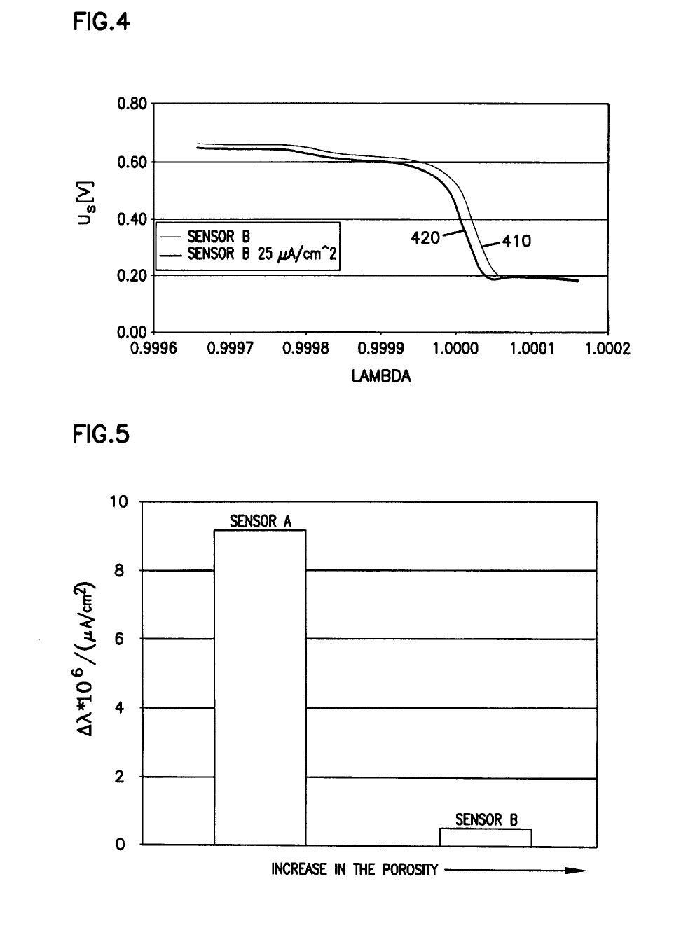

The sensor voltage U_{S} of a sensor A with exhaust gas electrodes of different coatings is depicted in FIG. 3. The sensor voltage U_{S} above the air number lambda of an additional exhaust gas sensor B is depicted in FIG. 4.

As it emerges from FIG. 3, the impression of a positive voltage potential on the exhaust gas electrode 120 leads to a significant displacement of the lambda step change in such a way, that a current density of 25 μA/cm² with regard to the macroscopic surface at the exhaust gas electrode 120 arises. In FIG. 3 and FIG. 4 the sensor voltages of different sensors are in each case depicted without a voltage potential present at the exhaust gas electrode 120 (curve 310, curve 410) and with a voltage potential present at the exhaust gas electrode 120 (curve 320, curve 420). The lambda step change is displaced to a value smaller than 1, as this is depicted schematically in FIG. 3 by an arrow.

The sensor A depicted in FIG. 3 has a smaller porosity than the sensor depicted in FIG. 4. In the case of the sensor depicted in FIG. 4, a smaller lambda-point-displacement occurs. The sensor in FIG. 4 has approximately a lambda-point-displacement of 0.5 ppm/(μA/cm²), whereas the sensor depicted in FIG. 3 has a lambda-step change-displacement of 9 ppm/(μA/cm²). The displacement of the step change position of the lambda-point with regard to the current density is depicted in FIG. 5 for two sensors (Sensor A and sensor B).

By means of the displacement of the step change position into the slight rich range due to an additional oxygen source, which is executed by the impression of the voltage potential between the reference electrode 110 and the exhaust gas electrode 120, another lambda step change can be detected especially using such an exhaust gas sensor as the exhaust gas sensor downstream from the catalytic converter in the rich range. This step change signals to a certain degree the beginning of the storage or depositing of oxygen in the three way catalytic converter. In this manner a saturation of the oxygen storage in the three way catalytic converter and an elevation of the nitrogen oxide proportions in the exhaust gas resulting from that oxygen saturation can effectively be prevented. The porous coating is—as mentioned above—is adjusted in such a way that a small current load on the pumping system is maintained. For this reason a small distortion of the sensor voltage results, which in turn brings with it the advantage, that small deterioration effects on the electrode resistors and the solid electrolyte resistor have only a minimal effect on the deterioration of the sensor voltage. Because the amount of the gases being transported from the inherently known (not depicted) protective pipe in front of the sensor and the mass flow of the exhaust gases is determined, the desirable, specifiable mass flow and the lambda step change displaced toward rich can be adjusted by the previously described combination, which is empirically determined, of the protective layer and the pumping current.

The protective layer 130 can—as already previously executed above—can consist of multiple porous protective plies of different porosities. The protective layer 130 has to limit the material transport to such an extent that in interaction with the oxygen, which has been pumped, the desired displacement of the lambda step occurs.

It is to be noted at this point that instead of the circuit arrangement discussed above and depicted in FIG. 2, in which the plus terminal of the voltage source is connected by way of a resistor 240 in series to the exhaust gas electrode 120, provision can also be made to dispose the series-connected resistor between the minus terminal of the voltage source and the reference electrode 110. Provision can, moreover, be made, in which the sensor with the series-connected resistor is integrated into a voltage divider arrangement, in order to perform a kind of voltage adaptation to the supply voltage of a control unit.

1. An arrangement including an exhaust gas sensor, especially a lambda probe, preferably for motor vehicles, containing at least one reference electrode disposed in a solid electrolyte and an exhaust gas electrode exposed to an exhaust gas, which has a porous ceramic coating, and including a circuit arrangement, through which an oxygen current flowing toward the exhaust gas electrode can be generated between a reference electrode and an exhaust gas electrode, wherein a size of the oxygen current is adapted to currents diffusing through the porous coating in such a way, that a targeted lambda-step change-displacement results.

2. An arrangement according to claim 1, further comprising a series circuit from a direct current voltage source, a resistor and the exhaust gas sensor, whereby a plus terminal of the voltage source is connected directly or by way of a series circuit with the resistor with the exhaust gas electrode, and a minus terminal is connected by a series circuit with the resistor, respectively directly with the reference electrodes.

3. An arrangement according to claim 1, wherein the porous coating has multiple plies.

4. An arrangement according to claim 3, wherein the plies of the porous coating in each case have different porosities.

5. An arrangement according to claim 1, wherein the exhaust gas sensor includes the circuit arrangement.
